(19) United States
(12) Patent Application Publication
(10) Pub. No.: US 2024/0112114 A1
(43) Pub. Date: Apr. 4, 2024

(54) MANAGEMENT OF JOB SAFETY ANALYSIS RECORDS

(71) Applicants: RANDALL DECKER, LA MARQUE, TX (US); STEPHEN H. SABOE, JR., PEARLAND, TX (US); GERRY TRACY, LEAGUE CITY, TX (US)

(72) Inventors: RANDALL DECKER, LA MARQUE, TX (US); STEPHEN H. SABOE, JR., PEARLAND, TX (US); GERRY TRACY, LEAGUE CITY, TX (US)

(21) Appl. No.: 17/958,732

(22) Filed: Oct. 3, 2022

(51) Int. Cl. G06Q 10/06; G06F 40/174; G06F 40/186

(52) U.S. Cl. CPC G06Q 10/0635; G06F 40/174; G06F 40/186

(57) ABSTRACT

A computer program product comprising a non-volatile computer readable medium that embodies non-transitory program instructions, where the program instructions are executable by a processor to cause the processor to perform various operations. The operations comprise: providing a graphical user interface (GUI) to a first computing device, wherein the GUI is configured to accept user input into a job safety analysis (JSA) record; receiving user input into the GUI, the user input identifying a plurality of hazards to be addressed by the JSA record; forming a module of the GUI for each of the plurality of hazards, where each module identifies one of the hazards and displays an element for receiving user input identifying one or more mitigation strategies for the identified one of the hazards; and preventing the JSA record from being identified as completed until receiving user input identifying the mitigation strategies for each of the plurality of hazards.

### BACKGROUND

The present disclosure relates to methods for performing a job safety analysis (JSA).

### BACKGROUND OF THE RELATED ART

A job safety analysis (JSA) is a procedure which helps integrate accepted safety and health principles, practices, applications and analysis into a particular task or job operation. The purpose of the job safety analysis is to identify potential hazards associated with the particular job and to recommend the safest way to do the job. Other terms used to describe this procedure include “job hazard analysis” (JHA), “job hazard breakdown,” “job loss analysis” or “tailgate safety review.” Often, acronyms such as JSA and JHA are used interchangeably in practice to refer to the same or similar process.

For well over two decades, the job safety analysis has been a required step before the start of work within refineries, petrochemical facilities and almost all other manufacturing facilities across the U.S. The intention of the job safety analysis is that each person assigned to the crew performing the work will participate in the job safety analysis process or session and that each person will be fully aware of the hazards associated with the job before the start of the work. Just about every contractor manually writes down the content of the job safety analysis on a piece of paper (i.e., performs a paper-based JSA process) to document that the job safety analysis was performed.

The US Department of Labor, through the Occupational Safety and Health Administration (OSHA) issued a 51-page publication in 2002 (twenty years ago) entitled “Job Hazard Analysis”, which defines the JHA process as follows: “A job hazard analysis is a technique that focuses on job tasks as a way to identify hazards before they occur. It focuses on the relationship between the worker, the task, the tools, and the work environment. Ideally, after you identify uncontrolled hazards, you will take steps to eliminate or reduce them to an acceptable risk level.”

In practice today, the job safety analysis is written on a non-standard paper form which may vary in content, design and application from user to user, industry to industry and the like. Typically, a company that owns a facility or workplace, or is working in a particular facility or workplace, will create their own job safety analysis form(s) for the type of work that their company (or contractor) performs, ideally identifying the particular hazards or risks within their own frame of reference. Often, the design and content of a job safety analysis form may be driven by past experiences, incidents or safety audits. However, one example of a job analysis form is provided in Appendix 3 (Sample Job Hazard Analysis Form) of Publication 3071 published by the Occupational Safety and Health Administration (OSHA) in 2002. This Publication further identifies and describes a long list of hazards (Appendix 2) and identifies various hazard control measures (Appendix 1).

### BRIEF SUMMARY

Some embodiments provide a computer program product comprising a non-volatile computer readable medium and non-transitory program instructions embodied therein, the program instructions being configured to be executable by a processor to cause the processor to perform various operations. The operations comprise: providing a graphical user interface to a first computing device, wherein the graphical user interface is configured to accept user input into a job safety analysis record; receiving user input into the graphical user interface, the user input identifying a plurality of hazards to be addressed by the job safety analysis record; forming a module of the graphical user interface for each of the plurality of hazards, where each module identifies one of the hazards and displays an element for receiving user input identifying one or more mitigation strategies for the identified one of the hazards; and preventing the job safety analysis record from being identified as completed until receiving user input identifying the one or more mitigation strategies for each of the plurality of hazards.

### BRIEF DESCRIPTION OF THE SEVERAL VIEWS OF THE DRAWINGS

FIG. 1 is a diagram of a system in which various embodiments of a job safety analysis (JSA) application may be implemented.

FIG. 2 is a diagram of a mobile computing device according to some embodiments.

FIG. 3 is a diagram of a computer according to some embodiments.

FIG. 4 is a diagram of a home screen of graphical user interface.

FIG. 5 is a diagram of a drop-down setup menu.

FIG. 6 is a diagram of an expanded home screen as it might appear on a notebook computer or monitor screen connected to a desktop computer.

FIG. 7 is a diagram of a new job safety analysis (JSA) screen

FIG. 8 is a diagram of a job safety analysis (JSA) selection screen, including a search bar and a drop-down menu of available JSA documents or records.

FIG. 9 is a diagram of a JSA list showing a newly initiated JSA ready to receive user input.

FIG. 10A is a diagram of a “start JSA” popup that may occur upon selection of the JSA from the JSA list.

FIG. 10B is a diagram of a “select crew member” popup or screen that may occur after starting the selected JSA.

FIG. 11 is a diagram of the JSA list of FIG. 9, but with the people icon in a green color to indicate completion and with the addition of a document icon representing that the main JSA section of the JSA record is now enabled for user input.

FIG. 12 is a diagram of a JSA record include JSA modules or sections displayed as cards that may be selected through user input.

FIG. 13 is a diagram of a hazard entry/selection screen or popup.

FIG. 14 is a diagram of a gravity-related hazards screen listing two gravity hazards.

FIG. 15 is a diagram of a screen for reviewing a specific gravity hazard, selecting one or more mitigation strategies, indicating whether there has been a change in conditions, indicating whether the hazard is immediately dangerous to life and health (IDLH), and whether the hazard has been checked by a supervisory.

FIG. 16 is a diagram of a screen for ending the JSA after reviewing each of the hazards.

FIG. 17 is a diagram of a screen illustrating user input providing a signature to be associated with the JSA record.

### DETAILED DESCRIPTION

Some embodiments provide a job safety analysis (JSA) application program. The JSA application may form a JSA record of the performance of a job safety analysis. Such JSA record may include one or more textual entries, audio input, image or video input, a participant list, geolocation and/or time stamps of various occurrences. The JSA application may guide a user through a series of operations in the performance of a job safety analysis and the initiation or creation of the job safety analysis record. Optionally, the JSA application may provide some level of guidance, assistance or control, such as imposing step-wise user input requirements to progress through the steps of the job safety analysis, prompting for input, providing a menu of selectable input, and the like.

Some embodiments of the JSA application may provide a graphical user interface that facilitates user interaction with the JSA application, including user input to the JSA application and output from the JSA application to a user. The graphical user interface may be adapted for display on various screens and devices and may be adapted to receive input from various input devices. For example, the graphical user interface may be displayed of various screens regardless of size, aspect ratio and operating system, including a mobile phone (for both iOS and Android devices), tablet screen, laptop screen, standalone display screen coupled to a desktop computer, a smart television, virtual reality or augmented reality glasses/goggles, and the like. Further, the graphical user interface may receive input via any input device available, including a touchscreen, mouse, trackpad, track ball, gesture-recognition device, microphone, camera, and the like.

Some embodiments of the JSA application may be directed to a computer program product comprising a non-volatile computer readable medium and non-transitory program instructions embodied therein, wherein the program instructions are configured to be executable by a processor to cause the processor to perform various operations. The operations may comprise providing a graphical user interface to a first computing device, wherein the graphical user interface is configured to accept user input into a job safety analysis record. The operations may further comprise receiving user input into the graphical user interface, the user input identifying a plurality of hazards to be addressed by the job safety analysis record, and forming a module of the graphical user interface for each of the plurality of hazards, where each module identifies one of the hazards and displays an element for receiving user input identifying one or more mitigation strategies for the identified one of the hazards. In addition, the operations may comprise preventing the job safety analysis record from being identified as completed until receiving user input identifying the one or more mitigation strategies for each of the plurality of hazards.

In some embodiments, each module may be arranged in a sequential order of modules. The operations may include enabling a current one of the modules to receive user input, displaying the current module of the job safety analysis record, receiving user input from the first computing device into the current module of the job safety analysis record, and preventing a next one of the modules from being enabled to receive user input until receiving user input identifying the one or more mitigation strategies for the hazard identified in the current module. The JSA application may provide a technical benefit of being able to require completion of one module before advancing to the next module to ensure that each hazard is addressed with at least one mitigation strategy. A job safety analysis that is documented on paper is not capable of ensuring that each hazard is addressed with a mitigation strategy.

In some embodiments, the operations may further comprise collapsing one or more of the modules of the graphical user interface that are not presently enabled to receive user input and expanding the current module of the graphical user interface to display one or more elements for receiving user input. Such collapsing and expanding of the modules makes efficient use of the amount of the graphical user interface that can displayed on a given display screen at any point in time. Furthermore, collapsed modules may be de-emphasized, but still identified, while the expanded modules are emphasized and display sub-modules and specific user interface elements available for receiving user input. Optionally, the one or more elements for receiving user input is a text box, button and/or a menu of items.

In some embodiments, the appearance of a title or icon representing each module or section of the JSA document may be altered to indicate whether or not the module has been completed and whether or not the module is currently enabled for receiving user input. In one example, the title or icon may be turned green, bold or have a check marked added adjacent the title or icon to indicate that the module has been completed, whereas the title or icon may be grayed out to indicate that the module is not currently enabled to receive user input. Further, the title, icon or data entry fields for a module that is currently enabled to receive user input may be outlined and various fields, buttons, menus and the like within the module may be responsive to user input. Still further, a module associated with an identified hazard that has not yet been reviewed (i.e., hazard and mitigation strategy discussed, edited, etc.) during the job safety analysis session may be emphasized by displaying a special icon, such as a red X, next to the title or icon for the identified hazard. During review of the hazard, the job leader or other user may modify the hazard description to more closely reflect the hazard for this particular job, may identify whether this is a significant hazard is immediately dangerous to life and health (IDLH), and may choose one or more mitigation strategy.

In some embodiments, each section or module of the JSA document may appear in the graphical user interface as a separate block or card. A button may be provided within each block or card to allow the user to identify whether or not the section or module is applicable to the job that is the subject of the job safety analysis session. Optionally, a module marked as being not applicable may be minimized in some manner. However, the user may be allowed to subsequently designate the module as being applicable, such as that module is returned into the order of module that must be addressed during the job safety analysis session. Each module or section of the JSA document, which may appear as a separate block or card, may be selected to enable entry or editing of a hazard type and description, as well as mitigation strategies and associated descriptions. For example, clicking or otherwise selecting a card associated with a particular module will open the card and allow the job leader or other user to identify one or more hazards and identify one or more mitigation strategy for reducing or eliminating the associated hazards. Optionally, the user may select one or more hazards from a default list of hazards or a customized list of hazards established by the administrator through the setup menu. Furthermore, the JSA application may allow the user to enter a hazard that is not in a list. Regardless of how the hazard is identified and entered into the JSA record, each hazard may form its own child record, field or set of fields within the JSA record.

In some embodiments, each of the plurality of hazards may be identified by receiving user input selecting from a predetermined menu of hazards. Separately, each of the one or more mitigation strategies for each identified hazard may be identified by receiving user input selecting from a predetermined menu of mitigation strategies for the identified hazard.

In some embodiments, the JSA application may have access to a database of past job incident records, where each job incident record may include some or all of the same information in a JSA record or may be associated with the JSA record that was created for the job that led to the job incident. Accordingly, the JSA application may use the location, equipment or job type of a newly initiated JSA record as a key to lookup any job incident records that are related to the location where the new job will be performed, related to the equipment involved in the new job, and/or the type or work that will be performed in the new job. The job incident records that are identified in the search or lookup may be automatically downloaded for display on the job leader's device (i.e., the device being used to perform the JSA session) to facilitate review of the prior relevant job incidents with the job team. Similarly, any important daily messages, such as weather forecasts or special notices regarding the job site, may also be downloaded for display on the job leader's device to be discussed with the job team.

In some embodiments, the operations of the JSA application may comprise accessing a collection of safety incident records, wherein each of the safety incident records reference one of a plurality of past job safety analysis records. The operations may further comprise identifying, for a subset of the job safety analysis records that each include an identified hazard, a safety effectiveness of one or more mitigation strategy identified in the job safety analysis record for mitigating the identified hazard, wherein the safety effectiveness is a measure of the relative number of safety incidents occurring while using the mitigation strategy during jobs that involved the identified hazard. Still further, the operations may include highlighting, within the predetermined menu of mitigation strategies for the identified hazard, at least one of the one or more of the mitigation strategies that have the greatest safety effectiveness.

Some embodiments of the JSA application may include a setup menu. A particular individual, entity or organization may use the setup menu to access functions or modules that allow establishment of a user profile and account settings. The setup menu may also be used to populate various lists and options that are relevant to the nature of the job safety analysis that is expected to be performed with the JSA application. After the initial setup, such lists and options may be incorporated into the JSA application to be quickly selected or entered, such as with drop down lists, radio buttons, auto-completion, and the like. The use of predetermined lists and options may promote consistency and avoid ambiguity. In one option, the setup menu and/or one or more of the functions or modules of the setup menu may be viewable and/or editable only by an information technology (IT) professional and/or an administrator responsible for the JSA application (e.g. safety department administrator).

In some embodiments, a setup menu may be populated with one or more default settings and/or entries that are subject to revisions, such as additions, deletions and customizations. As non-limiting examples, the setup menu may allow the following capabilities: (1) create a list of hazards that the user's company would typically need to consider in their line of business; (2) create a list of personal protective equipment (PPE) that field workers need to review and/or wear as conditions dictate; (3) setup one or more work site/facility name and related information (such as populating a hierarchy, such as (i) name of entity, (ii) name of facility/location, (iii) name of operating unit, and (iv) name of specific equipment; (4) setup the work site owner representative(s) and their contact information (i.e., email and phone number); (5) establish notification settings for the identified owner representative(s), such as an event to trigger a notification (i.e., the job safety analysis has started), a form of the notification (i.e., email and/or text), and content of the notification (i.e., an actionable connection (a phone number or a hyperlink, hereafter “link”) for remote participation, such as a link to audio or video of the job safety analysis in progress); (6) setup name, contact information and the like for a contractor, contractor personnel working at the work site, management, supervisions and the like; (7) setup user profile(s) and access/entry/editing permissions for the contractor and/or contractor personnel profile and access setup; (8) select or create one or more job safety analysis templates for one or more particular tasks, jobs, crafts, or entities, such as a job-specific job safety analysis form that can have one or more fields that are pre-populated for use with common or repetitive type work (e.g., scaffold building, pipe flange connections, heat exchanger disassembly, etc.); (9) craft-specific and/or skill-specific list of job safety analysis forms (i.e., boilermakers, pipefitters, scaffold builders, insulators, electricians, etc.); (10) access to historical records for a particular facility (i.e., cyanide gas, hydrofluoric acid, etc.), a particular job (i.e., demolition, excavation, etc.), a particular person (i.e., safety incidents), and the like; (11) access to one or more stock images that can be used to communicate a job hazard or mitigation strategy (e.g. for PPE, the user can add an image of the PPE and it will become part of the viewable description for the item); (12) access to mitigation strategies for the field users to discuss when addressing the hazards associated with their work; and/or (13) access to a checklist of items that the user may want to choose from while performing a job safety analysis (i.e., reminder to take and upload a picture of various job-related information, such as the personnel involved in the job safety analysis, specific equipment to be utilized, relevant work permit(s), confined space document, lock out tag out (LOTO) document, etc.).

Embodiments of the JSA application allow one or more user to initiate/create, edit, save, share and/or view some or all of a JSA record. Initiating a new JSA record may include, for example, entry of the current date, time and/or shift; a work order number for work to be performed; a customer name, unit and/or equipment; customer/owner contact for notifications; and/or contractor/provider representative. After initiating or creating a new JSA record, a user may select a JSA document or form based on the work to be performed. For example, the JSA document or form may have been previously setup by the administrator using a JSA builder tool. After selecting the relevant JSA document for the work/job, the JSA application may generate a parent table record for information to be included in a JSA header and generate related child records that represent steps that the user will be required to review, edit or enter within the JSA document or record. Optionally, the JSA application may require some or all of the foregoing information to be entered before enabling the user to enter additional information into the JSA document. This assures that the JSA is completed in a manner that meets minimum requirements set by the administrator.

Some embodiments of the JSA application promote participation of work site personnel in the job safety analysis. Furthermore, the JSA application may document the participation through verbal/voice recognition, pictorial or video recordation and electronic signatures.

Some embodiments of the JSA application facilitate remote participation by users (stakeholders) that are not present on the work site. For example, remote participation may be provided to one or more user (stakeholder), such as an owner, contractor, manager, safety expert, supervisor and crew member. Remote participation may include monitoring ongoing population of fields in a JSA form, receiving and/or interacting with live audio from the work site, and/or receiving and/or interacting with live video from the work site.

In some embodiments, after the new JSA document is initiated, the JSA application may enable entry of those personnel involved in the job safety analysis session. For example, a job leader may start the job safety analysis session, such as by selecting a “Start JSA” button on the graphical user interface. In response to user selection of the “Start JSA” button, the JSA application may record the current time as the start time and/or record the geolocation. In addition, the JSA application may then enable the job leader or other user to select or enter a name or other identifier for each person that is involved in the job safety analysis session. Optionally, the JSA application may require that some minimum number of participants be entered before enabling the user to enter additional information into the JSA document. This stepwise guidance through the JSA session, for example requiring completion of one section or module of the JSA document before enabling entry into another section or module of the JSA document, assures that each section or module of the JSA is adequately addressed.

Some embodiments of the JSA application may monitor and/or store audio and/or video input captured by a mobile device at the work site during performance of the job safety analysis. Optionally, audio and/or video capture may be automatically initiated at the beginning of the JSA session, such as in response to a first step of initiating or creating a new JSA record. Furthermore, a link to receiving and/or participating in the audio and/or video from the JSA session may be automatically sent within the notification to one or more previously identified devices, such as a device associated with a supervisor, customer and/or company representatives. Those receiving the notification may be previously identified in settings that are established in an initial JSA setup by a system administrator of job leader. The link may be used to form a network connection to the device being used to direct the live JSA session.

In some embodiments, the audio and/or video of the JSA session may be automatically stored as part of, or associated with, the JSA record. The stored audio and/or video may be subsequently accessed, such as for training purposes or as part of an incident investigation. In particular, the audio input may include the spoken words of personnel participating in the job safety analysis at the work site and/or the spoken works of remote users. Optionally, the spoken words in the audio input may be transcribed. Such a transcription may then facilitate an optional word count, which may be in indication of the level of engagement in the job safety analysis.

In some embodiments, the operations may further comprise receiving an audio stream from a microphone that is connected to the first computing device during a duration the user input into the job safety analysis record, performing voice analysis on the audio stream to determine a number of participants speaking in the audio stream, and storing the determined number of participants in association with the job safety analysis record.

In some embodiments, the operations may further comprise receiving an audio stream from a microphone that is connected to the first computing device, performing voice recognition on the audio stream to determine an identity of one or more participants speaking in the audio stream, and storing the determined identity of the one or more participants in association with the job safety analysis record.

In some embodiments, the operations may further comprise forming a network connection with a second computing device, wherein the first computing device is located on a job site during the job safety analysis and the network connection with the second computing device is independent of a network connection with the first computing device. The operations may additionally comprise receiving a first audio stream from a microphone that is connected—physically or via radio wave—to the first computing device during a duration of the user input into the job safety analysis record and receiving a second audio stream from a microphone that is connected to the second computing device during the duration of the user input into the job safety analysis record. Still further, the operations may comprise determining, using the first audio stream, a first amount of speaking; determining, using the second audio stream, a second amount of speaking; and storing a value representing the second amount of speaking relative to the first amount of speaking. For example, the relative amount of speaking in the second audio stream may be an indication of a level of involvement of a participant, supervisor or manager. As described herein, a microphone may be “connected” to a computing device by virtue of either being a component within the computing device or being an external component that communicates with the computing device through a wired (physical) or wireless connection.

In some embodiments, the operations may further comprise receiving an audio stream from a microphone that is connected to the first computing device during a duration of the user input into the job safety analysis record, forming or obtaining a transcription of spoken words in the audio stream, automatically determining a word count of the spoken words in the transcription, and automatically sending a notification to a second computing device associated with a predetermined user in response to detecting that the word count is less than a predetermined number.

In some embodiments, the operations may further comprise automatically sending a notification to a second computing device associated with a predetermined user in response to detecting that the first computing device has initiated or created a new job safety analysis record. In one option, the first computing device may be located on a job site during a duration of the user input into the job safety analysis record and the second computing device may not be located on the job site during the duration of the user input into the job safety analysis record. In another option, the notification may include a selectable link for the second computing device to form a network connection to receive a real-time feed of the user input to the job safety analysis record. For example, the real-time feed of the user input to the job safety analysis record may include an audio stream from a microphone that is connected to the first computing device.

In some embodiments, the operations may further comprise automatically sending a notification to a second computing device associated with a predetermined user in response to detecting that the first computing device has modified a previously completed job safety analysis record. Optionally, a “change in condition” indicator or flag may be associated with a JSA record. For example, the “change in condition” indicator or flag may be associated with a JSA record in response to the JSA record being reopened and revised, such as to add a new hazard.

Some embodiments may automatically store JSA records, such as updating a previously stored JSA in response to each modification (i.e., addition, deletion or change) or upon some other event. For example, the JSA record may be stored upon completion of the JSA record, upon completion of any one field of the JSA record, or upon closing the JSA app or the device on which JSA app is running. Optionally, the JSA records may be stored on a local data storage device and/or on a remote data storage device, such as cloud storage or a storage area network. A records retention policy may govern the duration of storage and a privacy policy may govern individuals or entities that are authorized to access some subset or all of the JSA records.

Some embodiments may perform voice recognition on the audio input to identify one or more individuals participating in the job safety analysis and/or to determine a number of individuals (with or without identifying the individuals) participating in the job safety analysis. For example, words spoken by different individuals may have distinguishable inflections or other characteristics that enable the number of individuals that spoke during the job safety analysis. In combination with a word count feature, JSA metrics may determine a percentage of participation by an individual speaker. Similarly, the audio input may include words spoken by a remote participant, which may provide a metric of company and customer management or subject matter expert participation in the JSA.

In some embodiments, the operations may further comprise receiving an image from a camera that is connected to the first computing device, performing image analysis on the image to determine a number of participants present during the user input into the job safety analysis record, and storing the number of participants in association with the job safety analysis record.

In some embodiments, the operations may further comprise receiving an image from a camera that is connected to the first computing device, performing facial recognition on the image to determine an identity of one or more participants present during the user input into the job safety analysis record, and storing the identity of the one or more participants in association with the job safety analysis record.

In some embodiments, the operations may further comprise receiving a geolocation from a geolocation sensor on the first computing device during a duration of user input into the job safety analysis record and storing the geolocation of the first computing device in association with the job safety analysis record.

In some embodiments, the operations may further comprise storing or obtaining a first timestamp in response to initiation of user input into the job safety analysis record, storing or obtaining a second timestamp in response to completion of user input into the job safety analysis record, and automatically sending a notification to a second computing device associated with a predetermined user in response to detecting that a duration of time between the first timestamp and the second timestamp is less than a predetermined amount of time.

In some embodiments, the operations may further comprise forming a network connection with a second computing device authenticated with the administrative credentials and enabling the second computing device to form one or more template for a job safety analysis record directed to one or more jobs, crafts, and/or entities, wherein each template is formed with one or more modules or fields that are pre-populated.

In some embodiments, the operations may further comprise automatically searching historical safety incident records to identify one or more safety incident record having the same job, person or location as the job safety analysis record, and displaying at least a portion of the one or more identified safety incident records on the graphical user interface for review during a duration of user input to the job safety analysis record.

In some embodiments, the operations may further comprise receiving user input forming a list of participants present during the user input into the job safety analysis record and receiving and storing an electronic signature from each of the listed participants in association with the job safety analysis record. Optionally, the operations may comprise prompting each of a plurality of participants in the job safety analysis record to enter a signature prior to the completion of the job safety analysis record and preventing a status identifier for the job safety analysis record from indicating that the job safety analysis record has been completed without receiving a signature from each participant.

In some embodiments, the JSA record may be marked as completed in response to reviewing each of the hazards and associated mitigation strategies identified in the JSA record. Optionally, an “end JSA session” button may be activated for accepting entry only in response to completion of the JSA record. In another option, each person involved in the job safety analysis session (i.e., each member of a job team) may be required to sign the JSA record. For example, the JSA record may provide a prompt and/or signature area for each person to sign with a stylus or finger on a touchscreen of the same device used to review the JSA record. The JSA application may then automatically send an alert or notification to a device associated with a supervisor in response to each person that is a member of the job team having signed the JSA record. The supervisor receiving the notification of completed JSA record may then view, approve/reject and/or take other actions regarding the JSA record on their own device. The work team preferably will not begin performing the job until the supervisor has marked the JSA record as being approved. Furthermore, a portable document format (PDF) text document or text file, such as a Microsoft Word document, may be automatically generated and attached to the JSA record, where the document includes all the identified hazards, mitigation steps and crew member signatures.

In some embodiments, the operations may further comprise automatically sending a notification to a second computing device associated with a predetermined user in response the status identifier associated with the job safety analysis record indicating that the job safety analysis record has been completed, receiving a reply from the second computing device indicating that the completed job safety analysis record has been reviewed by the predetermined user, and storing a second status indicator indicating that the job safety analysis record has been reviewed by the predetermined user associated with the second computing device.

In some embodiments, each JSA record may indicate whether or not a supervisor has checked the JSA record. For example, a “checked by supervisor” indicator may be toggled from NO to YES, or other change in visual appearance, in response to input from the supervisory. Preferably, this indicator or field may only be changed by a user with supervisory credentials relative to the JSA record. Optionally, the supervisor may be required to review each step or module of the JSA record before the JSA application will enable the JSA record to be marked as being “checked by supervisor.” For example, the JSA application may require that a user with supervisory credentials view each module of the JSA record before a button on the graphical user interface is enabled to receive input that the JSA record has been “checked by supervisor.”

In some embodiments, the operations may further comprise storing, for each of a plurality of job safety analysis records, the job safety analysis record in a database, wherein each job safety analysis record includes an identity of a job site and identifies whether the job safety analysis record has been completed. The operations may also comprise receiving user input identifying a particular job site to be searched, searching the database for job safety analysis records associated with the particular job site, and displaying a map of the particular job site showing, for each job safety analysis record associated with the particular job site, an icon indicating the location within the particular job site where there is a job safety analysis that is in progress (i.e., a job safety analysis document that has been initiated but not been completed).

Some embodiments the JSA application may provide reporting on JSA records relating to currently ongoing jobs (i.e., JSA records that have been initiated but not completed). In one option, a report may rank currently ongoing jobs based on a risk of an unsafe condition or event. Such report may facilitate management attention or participation in the job safety analysis or selection of mitigation strategies for the jobs that have the greatest potential for an accident or injury. Separately, the JSA application may provide a map of the work site that identifies the location of each job safety analysis that is currently ongoing. For example, the individual locations may appear as a pin-drop and may form a link that takes a user into the relevant JSA record, optionally including joining a live audio connection or stream to participate in the job safety analysis.

In some embodiments, the operations may further comprise assigning a hazard score to each of the plurality of hazards in a predetermined menu of hazards and calculating, for each of a plurality of job safety analysis records that are in progress, a total hazard score as the sum of the hazard scores for each of the hazards identified in the job safety analysis record. The operations may also comprise ranking the job safety analysis records that are in progress in order of the total hazard score and providing the ranking to a second computing device.

In some embodiments, the operations may further comprise receiving biometric data from one or more health monitoring devices worn by a person during performance of a job that is the subject of the job safety analysis record. Optionally, the health monitoring device may include a heart rate sensor, body temperature sensor, electrocardiogram sensor, pedometer and/or posture sensor. The operations may also comprise analyzing, for each of the one or more health monitoring devices, the biometric data to identify a health alert for the person associated with the health monitoring device, and automatically sending a notification to one or more computing devices indicating that the person wearing with the health monitoring device should use a mitigation strategy to address the health alert.

Some embodiments may pair with, or otherwise communicate with, one or more health monitoring or tracking devices worn by personnel performing a job, such as a heart rate monitor, smart watch, pedometer, posture sensor and the like. Input from such health monitoring devices may be shared with the JSA application and used to determine the existence of an unsafe condition and/or whether the mitigation strategies are sufficient or being properly employed. Other biometric devices and measurements may be similarly monitored and considered in making these or other determinations. Optionally, the biometrics may be used to trigger a break in the work and/or trigger additional mitigation strategies. For example, should be monitored biometrics indicate potential heat stress or exhaustion, the JSA application may automatically send a notification to one or more user indicating that personnel should take a break, seek out air conditioning, hydrate and/or switch to another task.

In some embodiments, audio input may be used to identify a mental state of an individual participant, such as a sentiment, attitude, emotion, and/or behavior. For example, a mental state may be characterized using certain types of words and vocal inflections. In one option, the audio input may be used to identify a behavior of an individual participant, such as active engagement or passive observation of the job safety analysis. In yet another option, the audio input may be used to identify proper or improper subject matter knowledge, such as knowledge of the hazards and/or knowledge of mitigation strategies. In a still further option, the audio input may be used to identify fitness for the job that is the subject of the job safety analysis, such as delayed response indicating a lack of sleep or slurred speech indicating a medical condition, intoxication or other impairment. Voice recognition, characterization or other analysis may be performed in any available manner, including the use of third-party services and/or the use of artificial intelligence. For example, the operations may further comprise receiving an audio stream from a microphone that is connected to the first computing device, performing speech analysis on the audio stream to determine whether any one or more of the participants in the job safety analysis are exhibiting an unsafe condition selected from mental state, behavior, medical condition, intoxication and/or a lack of knowledge about the job, and automatically sending a notification to a second computing device identifying a determined unsafe condition.

In some embodiments, the JSA record may identify a smart device that is associated with one or more of the personnel on the job team. Each smart device may run an agent application that is able to directly or indirectly communicate with other smart devices that are associated with the JSA record. Each agent application may monitor for input from an associated person on the job team indicating that an unsafe condition exists, and the job should be halted. For example, the agent application may generate a graphical user interface with a touch activated button on the smart device. Accordingly, the person may activate the button to promptly share a notification with the other smart devices. Optionally, the job would not be resumed until the JSA record was reopened and some acknowledgement of the unsafe condition is entered prior to restating the job. In one implementation, the operations of the computer program product may further comprise establishing, for each of a plurality of participants in the job safety analysis record, communication with a smart device that is associated with the participant, monitoring for input from the smart device associated with each participant, receiving a user input from the smart device of one or more participant indicating that an unsafe condition exists, and automatically sending a notification to the first computing device indicating that user input was received indicating that the unsafe condition exists.

Some embodiments of the JSA application may further integrate advertising into the graphical user interface, such as an advertisement for safety-focused products and services related to a job or risk that is the subject of the current job safety analysis.

Some embodiments of the JSA application may provide a unique graphical user interface for each type of user or stakeholder, such as a unique client page or app, a unique contractor page or app, and the like. Accordingly, each unique user interface may access the JSA records and present some or all of the data in a manner that is most valuable to the particular type of user or stakeholder. For example, a unique graphical user interface may have different JSA metrics, a subset of historical JSA records, different personnel records, and other differences. Personnel records may identify worker training, experience and safety records that are relevant to the particular type of user or stakeholder. A personnel record may include a number and type of past job safety analysis session in which the individual person has participated.

Some embodiments perform quantitative and/or qualitative analysis of the JSA records to form one or more JSA metrics. For example, each job safety analysis record or form, whether completed or incomplete, may be an electronic file or document that may be automatically analyzed, tracked and searched. Accordingly, JSA metrics may be updated in real time. The graphical user interface of the JSA application provides an optional JSA metrics dashboard or page where standard and/or customized reports, analysis and statistics may be displayed.

Non-limiting examples of such JSA metrics may include: (i) a number of completed JSA records; (2) an amount of time to complete a JSA as shown by timestamps for various entries in a JSA record; (3) an amount of time for the supervisor to approve the JSA using timestamps for completion and approval of a JSA record; (4) an average amount of time to perform the JSA process; (5) a percentage of JSAs that are completed at the work site as indicated by global positioning system (GPS) coordinates or similar indications; (6) a percentage of JSAs where the supervisor was at the work site to check the JSA; (7) a tabulation of each type of hazards that are being identified and the mitigation steps taken.

Other JSA metrics may include trend analysis and the effect of new mitigation strategies, new equipment, new safety rewards programs and the like. Accordingly, the JSA metrics may identify the effect of that change in procedures or conditions may have on job safety outcomes. In one option, each JSA record may further include, or may be correlated with, a safety outcome, such as an indication that no incident occurred at the work site during performance of the job or an injury of some particular severity occurred. In another option, the JSA metrics may identify or report one or more action item to be targeted for possible improvement in work site safety.

Some embodiments may perform a comparison of one or more JSA metric among work groups, work sites, companies, and industries. Comparisons of JSA metrics for various groupings of JSAs may facilitate the rapid identification of practices and procedures that are working to promote safety and those that are not. Such JSA metrics may identify mitigation strategies that have been effective to promote safety for one group performing a particular type of job and those identified mitigation strategies may then be recommended to another group performing the same type of job.

In some embodiments, the JSA application may provide for various standard reports and/or customized reports. For example, a standard report might provide details of all JSA records for the day at some particular work site. As another example, a standard report might provide the length of each JSA session handled by a particular job leader.

In some embodiments, the JSA application may access stored JSA records and may make each field of the stored JSA records searchable. Using the search function, a user may locate and review one or more stored JSA record that includes the search term(s). For example, a user may search for previous JSA records that deal with a particular hazard so that the user may also view the mitigation strategies that were used. In another example, a user may search to previous JSA records that involved a particular person so that the user may see how many jobs that person was involved in and the types of hazards that they have dealt with.

In some embodiments, the JSA application may enable a user to setup automatic notifications based upon wide range of conditions, events or information. As an example of a notification triggered in response to a condition, a user may setup a notification so that they receive a notification in response to a new JSA record being initiated with an identified hazard of a specific type. Such user may have some expertise in mitigation of the identified hazard and may be given the opportunity to provide input to the JSA session. As an example of a notification triggered in response to an event, a user may setup a notification so that they receive a notification in response to a user making a change to a completed JSA record. As an example of a notification triggered in response to certain information, a user may setup a notification so that they receive a notification in response to a JSA being completed from beginning to end in less than a predetermined amount of time. Such user may be responsible for safety and recognize that a JSA session of such brevity may suggest that the hazards were not sufficiently discussed during the JSA session.

In some embodiments, the JSA application may be run on a remote computer, such as a remote server operated by a JSA service provider. The JSA application may interact with mobile smart devices at the work site, remote management computers, and/or third-party services. The smart devices and/or remote management computers may run an agent application (“app”) that facilitates input and output with the JSA application. Alternatively, the smart devices and/or remote management computer may use a web browser application that displays an interface provided by the JSA application. In either configuration or some other configuration, user input is received by a mobile smart device at the work site and/or the remote management computer and then communicated to the JSA application over a network connection. The JSA application may also provide output to the mobile smart device and/or the remote management computer.

In some embodiments, the JSA application may access one or more third-party services to perform one or more function of the JSA application described herein. For example, the functions of audio transcription, voice recognition and/or sentiment analysis may be performed by a third-party service. Specifically, streaming and/or recorded audio may be directed or submitted to a third-party service provider over the network and receive a transcript, name of a person identified in the audio, number of different people identified in the audio, and/or the sentiment of any one or more of the people speaking in the audio. Without limitation, Amazon Transcribe, a service offered by Amazon Web Services, provides an automatic speech recognition service that converts speech to text. Alternative audio recognition tools and services are commercially available or in development at the time of this writing.

In some embodiments, a location with a significant hazard at the job site may be marked with a Bluetooth tag or beacon and/or marked with a geotag. When a participant with a smart device nears the location of one of these tags while performing the work, the smart device associated with the participant may receive a text message, audible alert and/or a physical notification (vibration or other haptic output) alerting the participant that they are nearing the location of the significant hazard. Optionally, the notification may include one or more mitigation instructions. Optionally, the identified location of the hazard within a job site may be associated with a particular job safety analysis record. Preferred embodiments may further include establishing, for each of a plurality of participants in the job safety analysis record, communication with a smart device that is associated with the participant, such as being worn by the participant.

The foregoing computer program products may further include program instructions for implementing or initiating any one or more aspects of methods described herein. It should also be understood that one or more aspects of some embodiments may be combined with one or more aspects of other embodiments, without limitation. Embodiments may also include systems or apparatus that perform the program instructions. For example, apparatus embodiments may comprise at least one non-volatile storage device storing program instructions and at least one processor configured to process the program instructions, wherein the program instructions are configured to, when processed by the at least one processor, cause the apparatus to perform various operations.

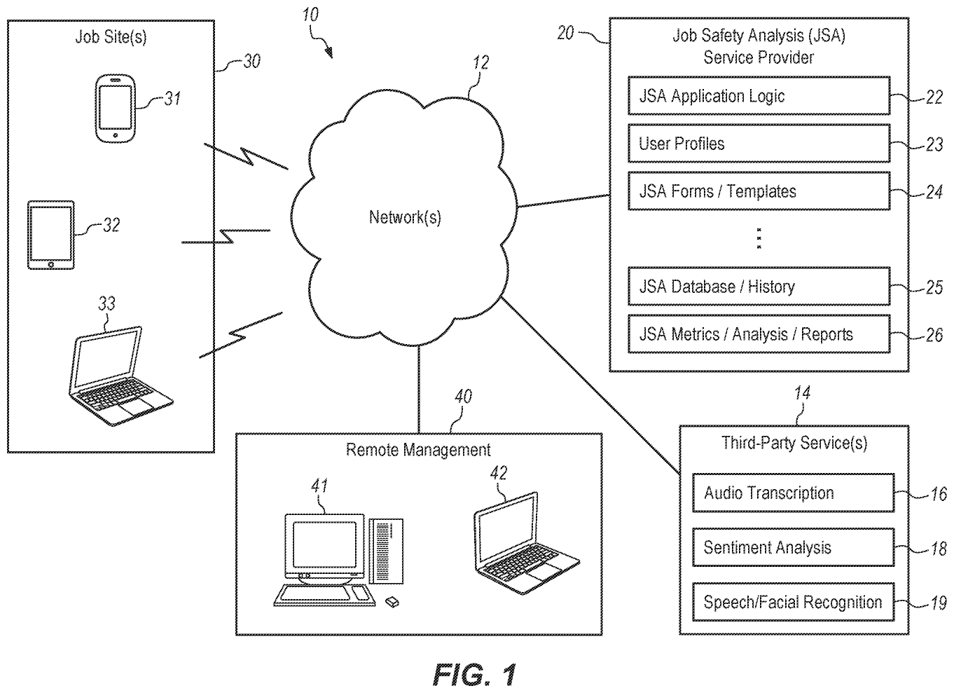

FIG. 1 is a diagram of a system 10 in which various embodiments of a job safety analysis (JSA) application may be implemented. In the illustrated system, a JSA application service provider 20 may run a JSA application 22 and provide JSA services to one or more remote computing devices. The JSA application 22 may run on one or more server, a server cluster, or a public and/or private cloud and may communication with one or more remote computing devices. For example, some remote computing devices may be used on one or more job site 30 and/or one or more management location 40. Accordingly, the JSA application 22 may communication with the job site computing devices 31, 32, 33 and/or the management computing devices 41, 42 over a network 12. The network 12 may be a wide area network, such as the Internet or other available communication network. Optionally, each of the computing devices 31, 32, 33, 41, 42 may run a user application that coordinates communication with the JSA application 22 over the network 12.

In a non-limiting example, the JSA application (programming logic) 22 may work in combination with one or more data sources, such as user profiles 23, JSA forms and/or templates 24, JSA database and/or history 25, and JSA metrics, analysis and/or reports 26. For example, the user profiles 23 may identify user accounts or contact information that enables the JSA application 22 to communicate with the computing devices being operated by certain users. A job leader and/or other users may operate a computing device, such as a smartphone 31, a tablet computer 32 or a notebook computer 33, at the job site 30 to perform a job safety analysis prior to performing a job at the job site 30. Specifically, one of the computing devices 31, 32, 33 may be used to communicate with the JSA application 22 to initiate or create a job safety analysis record, identify hazards associated with a planned job or task, identify mitigation strategies to be used by workers that are participating in the job safety analysis session where the job safety analysis record is being populated and/or reviewed. Other users, such as management or supervisory users, may indirectly and/or remotely participate in the job safety analysis session without being present on the job site 30. One of the computing devices, such as the desktop computer 41 and/or the notebook computer 42, may be used to remotely participate in the job safety analysis session where the job safety analysis record is being prepared, discussed, and/or reviewed by a user or work crew.

The JSA application 22 may optionally communicate with one or more third-party services 14 in order to access resources of the third-party services. For example, one or more third-party service 14 may be used to obtain audio transcription 16, sentiment analysis 18, and/or speech or facial recognition 19. For this purpose, the JSA application 22 may send an audio stream or file, video stream or file, or an image to the third-party service 14 over the network 12 and subsequently receive a transcription, participant sentiment, or participant identity from the third-party service 14 over the network 12.

The JSA application 22 may perform a wide variety of embodiments described herein. For example, the JSA application 22 may generate a graphical user interface and communicate with any of the computing devices 31, 32, 33, 41, 42 over the network 12 to render and display the graphical user interface on a screen connected to the computing device. Furthermore, the computing devices 31, 32, 33, 41, 42 may receive user input and transmit that user input to the JSA application over the network 12. Without limitation, the computing devices may receive user input via a touchscreen, keyboard, pointing device (i.e., mouse, trackpad, joystick, etc.), gesture sensors, microphone, camera, or other input device. The JSA application 22 may also send notifications, such as email or text message, to any or all of the computing devices and/or other devices responsive to certain conditions as described herein.

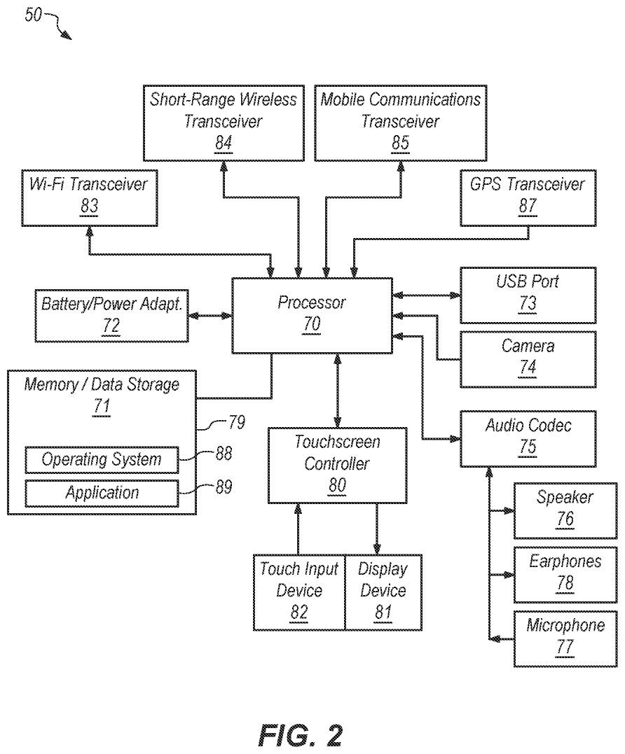

FIG. 2 is a diagram of a mobile computing device 50 according to some embodiments. The mobile computing device 50 may be representative of one or more of the computing devices 31, 32, 33 in FIG. 1. The mobile computing device 50 may include a processor 70, memory or data storage device 71, a battery (or other power source) 72, a universal serial bus (USB) port 73, a camera 74, and an audio codec 75 coupled to a built-in speaker 76, a microphone 77, and an earphone jack 78. The second appliance 50 may further include a touchscreen controller 80 which provides a graphical output to the display device 81 and an input from a touch input device 82. Collectively, the display device 81 and touch input device 82 may be referred to as a touchscreen.

The second appliance 50 may also include a short-range wireless transceiver 84, a wireless local area network transceiver (“Wi-Fi transceiver”) 83, a mobile communication transceiver 85 for communication with a cellular communication network, and a global positioning system (GPS) transceiver 87. Accordingly, the Wi-Fi transceiver 83 enables the formation of a wireless local area network connection with the Wi-Fi box 29 of FIGS. 1 and 2.

The memory 71 may store one or more applications including program instructions that are executable by the processor 70. Such applications may include an operating system 88 and an application 89 that may facilitate communication with the job safety analysis (JSA) service provider.

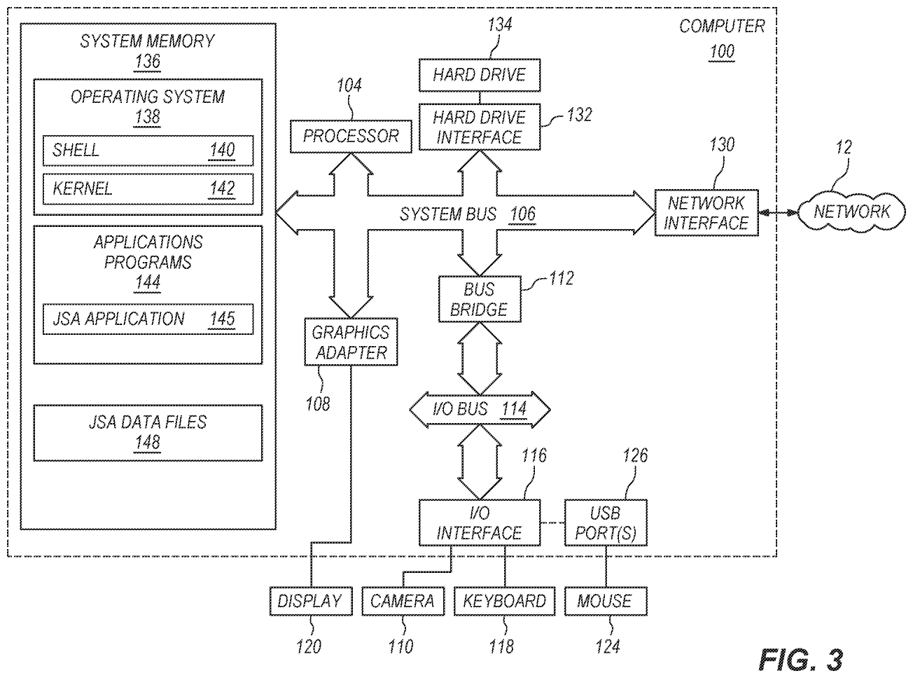

FIG. 3 is a diagram of a computer 100 according to some embodiments. The computer 100 may be representative of one or more of the job-site computing devices 31, 32, 33, one or more of the remote management devices 34, 35, one or more server that supports the functionality of the job safety analysis (JSA) service provider, and/or one or more server that supports the functionality of the third-party service(s) shown in FIG. 1.

The computer 100 includes a processor unit 104 that is coupled to a system bus 106. The processor unit 104 may utilize one or more processors, each of which has one or more processor cores. A graphics adapter 108, which drives/supports the display 120, is also coupled to system bus 106. The graphics adapter 108 may, for example, include a graphics processing unit (GPU). The system bus 106 is coupled via a bus bridge 112 to an input/output (I/O) bus 114. An I/O interface 116 is coupled to the I/O bus 114. The I/O interface 116 affords communication with various I/O devices, including a camera 110, a keyboard 118 (such as a touch screen virtual keyboard), and a USB mouse 124 via USB port(s) 126 (or other type of pointing device, such as a trackpad). As depicted, the computer 100 can communicate with other computing devices via the network 32 using a network adapter or network interface controller 130. For example, the computer 100 may communicate with the application server 33 and appliances shown in FIG. 1.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as a lowest level of volatile memory in the computer 100. This volatile memory may include additional higher levels of volatile memory (not shown), including, but not limited to, cache memory, registers and buffers. Data that populates the system memory 136 may include an operating system (OS) 138 and application programs 144. The hardware elements depicted in the computer 100 are not intended to be exhaustive, but rather are representative. For instance, the computer 100 may include non-volatile memory and the like.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 140 may be a text-based, line-oriented user interface, embodiments may support other user interface modes, such as graphical, voice, gestural, etc.

As depicted, the operating system 138 also includes the kernel 142, which may include lower levels of functionality for the operating system 138, including providing essential services required by other parts of the operating system 138 and application programs 144. Such essential services may include memory management, process and task management, disk management, and mouse and keyboard management. As shown, the computer 100 includes application programs 144 in the system memory of the computer 100, including, without limitation, the JSA application logic or program 145 including program instructions that may be executed by the processor 70 to cause the performance of various operations according to embodiments disclosed herein. The system memory 136 may also include the JSA data files 148, such as the user profiles, JSA forms and templates, JSA database/history and/or JSA metrics, analysis and reports set out in FIG. 1.

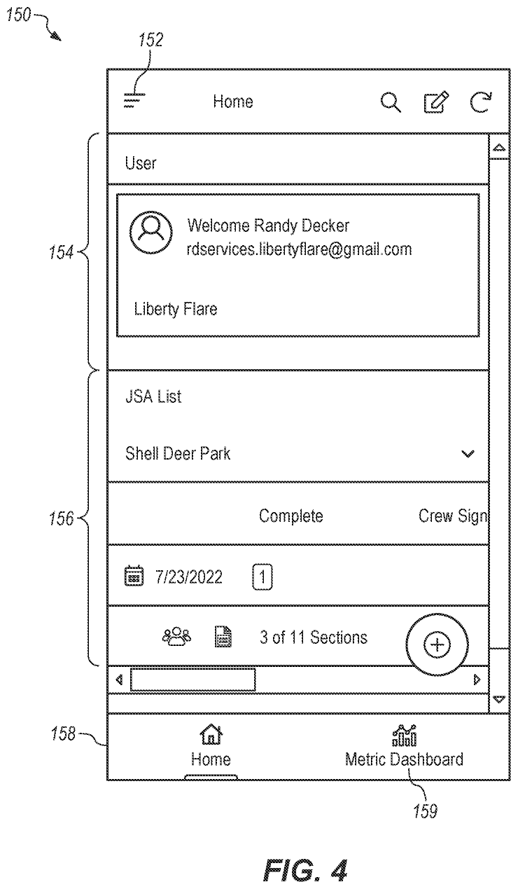

FIG. 4 is a diagram of a graphical user interface 150. The graphical user interface (GUI) 150 is shown here formatted for a smartphone screen, the GUI may also be formatted for any computing device having any available screen type or size. The graphical user interface 150 includes a setup menu icon 152, a user profile 154, a main section or module 156 for initiation/creation, entry and completion of one or more job safety analysis records, and a bottom ribbon 158 including a metric dashboard icon 159. Other features, such as a home button, search button, notes button and reload button may also be included.

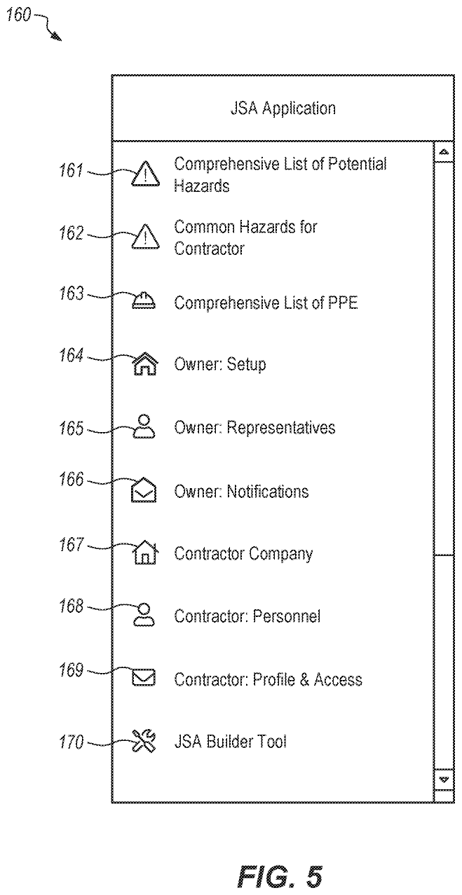

FIG. 5 is a diagram of a drop-down setup menu 160. The drop-down setup menu 160 may be displayed in response to selecting (clicking) the setup menu icon 152 of FIG. 4. Using the menu, an administrative user may setup various lists, contacts, and templates. The illustrated setup menu allows the following selectable menu items: (1) “Comprehensive List of Potential Hazards” button 161 for creating or editing a list of hazards that the user's company would typically need to consider in their line of business; (2) “Common Hazards for Contractor” button 162 for creating or editing a list of hazards that a contractor would typically need to consider in their line of business (3) “Comprehensive List of PPE” button 163 for creating and editing a list of personal protective equipment (PPE) that field workers need to review and/or wear as conditions dictate; (4) “Owner: Setup” button 164 for setting up one or more work site/facility name and related owner information (such as populating a hierarchy, such as (i) name of entity, (ii) name of facility/location, (iii) name of operating unit, and (iv) name of specific equipment; (5) “Owner: Representatives” button 165 for setting up the work site owner representative(s) and their contact information (i.e., email and phone number); (6) “Owner: Notifications” button 166 establish notification settings for the identified owner representative(s), such as an event to trigger a notification (i.e., the job safety analysis has started), a form of the notification (i.e., email and/or text), and content of the notification (i.e., a link for remote participation, such as a link to audio of the job safety analysis in progress); (7) “Contactor Company” button 167 for setting up a name and information for a contractor company; (8) “Contractor: Personnel” button 168 for setting up contact information and the like for a contractor, contractor personnel working at the work site, management, supervisions and the like; (9) “Contractor: Profile & Access” button 169 for setting up user profile(s) and access/entry/editing permissions for the contractor and/or contractor personnel profile and access setup; and (10) “JSA Builder Tool” button 170 for selecting or creating one or more job safety analysis templates for one or more particular tasks, jobs, crafts, or entities, such as a job-specific job safety analysis form that can have one or more fields that are pre-populated for use with common or repetitive type work (e.g., scaffold building, pipe flange connections, heat exchanger disassembly, etc.).

The illustrated drop-down setup menu 160 may include additional options that are not displayed but are accessible by scrolling downward on the graphical user interface such as by using the vertical scroll bar on the right-hand side of the setup menu. The additional selectable menu items may include, without limitation: (11) craft-specific and/or skill-specific list of job safety analysis forms (i.e., boilermakers, pipefitters, scaffold builders, insulators, electricians, etc.); (12) access to historical records for a particular facility (i.e., cyanide gas, hydrofluoric acid, etc.), a particular job (i.e., demolition, excavation, etc.), a particular person (i.e., safety incidents), and the like; (13) access to one or more stock images that can be used to communicate a job hazard or mitigation strategy (e.g. for PPE, the user can add an image of the PPE and it will become part of the viewable description for the item); (12) access to mitigation strategies for the field users to discuss when addressing the hazards associated with their work; and/or (15) access to a checklist of items that the user may want to choose from while performing a job safety analysis (i.e., reminder to take and upload a picture of various job-related information, such as the personnel involved in the job safety analysis, specific equipment to be utilized, relevant work permit(s), confined space document, lock out tag out (LOTO) document, etc.).

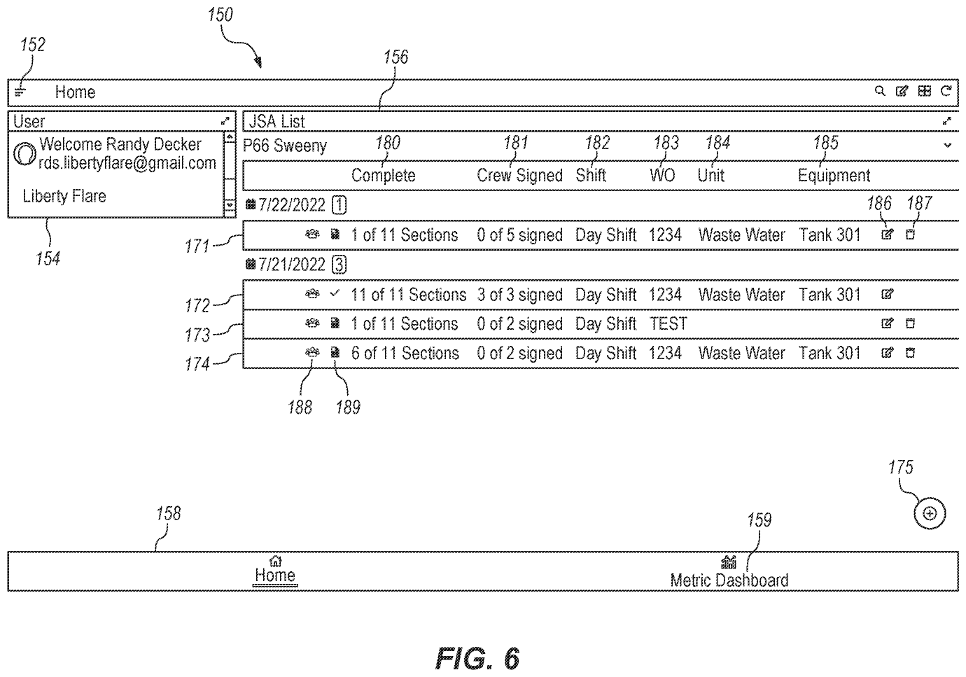

FIG. 6 is a diagram of an expanded home screen 150 as it might appear on a notebook computer, tablet computer, or a monitor screen connected to a desktop computer. From the home screen 150, a user may initiate/create, edit, complete and view JSA records 171-174 and related information. To initiate or create a new JSA record, an “Create New JSA” button or “+” icon 175 may be used.

In this illustration, each of the JSA records 171-174 forms a row of a table having various column headers and other information. A “Complete” column 180 may identify a number of sections or modules of the JSA record are complete. A “Crew Signed” column 181 may identify a number of personnel signatures have been collected for the JSA record. Additional columns include a “Shift” designation 182, a work order (WO) number 183, a unit identifier 184, and an equipment identifier 185. Additional notes may be entered via the “Notes” icon 186 and the JSA record may be deleted via the “Trash” icon 187. A “Personnel” of “Participant” icon 188 may be provided to access a list of personnel involved and the color (not shown) of the icon may indicate whether the personnel have been entered into the JSA record. Similarly, the “JSA document” icon 189 may be provided to access the JSA card view or main user input sections or modules of the JSA record. Upon completion of the JSA record, the “JSA document” icon 189 may be converted from a document symbol to a checkmark. For example, the JSA record 172 shows that “11 of 11 Sections” were completed (see column 180) and the “JSA document” icon 189 now appears as a check mark.

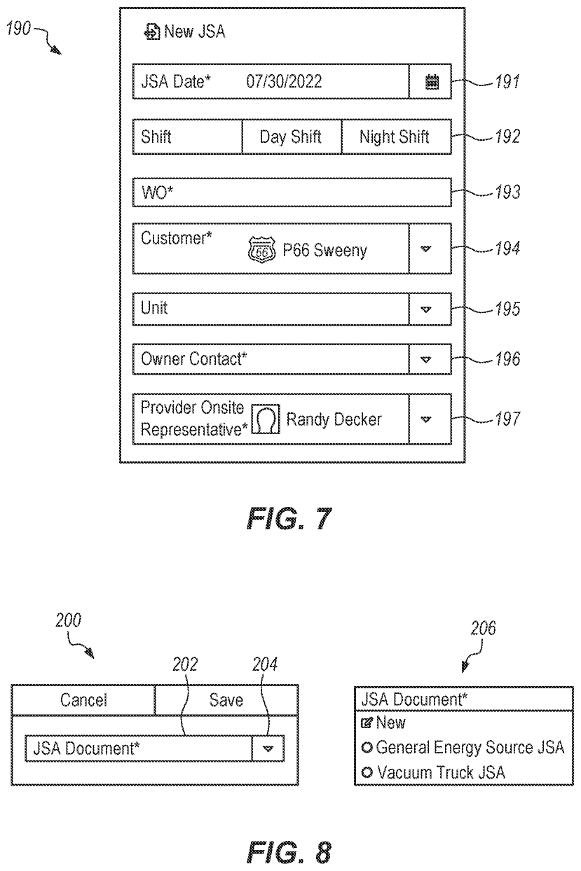

FIG. 7 is a diagram of a new job safety analysis (JSA) record screen 190. For example, the new job safety analysis (JSA) record screen 190 may be displayed in response to selecting the “Create New JSA” button or “+” icon 175 in FIG. 6. Using this screen 190, a user may the following entries: (1) a date field 191 for the current date or other date with or without use of a calendar; (2) a shift field 192 for the current shift, such as day or night shift (Day is the default); (3) a work order (WO) number field 193 (i.e., a client generated number designating the work to be performed); (4) a customer name field 194; (5) a customer unit field 195 (note that once the unit is selected, another field may be displayed with the related customer equipment to be selected (e.g. E101, T503, etc.); (6) an owner contact field 196, perhaps selectable from a list of contacts that the user would want to notify when the JSA is started (Note: the admin can setup certain people to always receive the notifications (e.g. owner safety representative); and (7) a provider onsite representative field 197, which may optionally be automatically filled in based on user login.

FIG. 8 is a diagram of a job safety analysis (JSA) document selection screen 200, including a search bar 202 and a drop-down menu 204 of available JSA documents or records. Immediately following the completion of the Add JSA step per FIG. 7, the user may be presented with the screen 200 to identify a JSA document. Here, the user chooses the appropriate JSA document based on the work to be performed. Optionally, the JSA documents may have been created previously using the JSA Builder Tool located in the Main Menu. For example, upon selecting the drop-down menu 204, the screen 206 may list available JSA documents or records. User input may then select one of the available documents or records as a template.

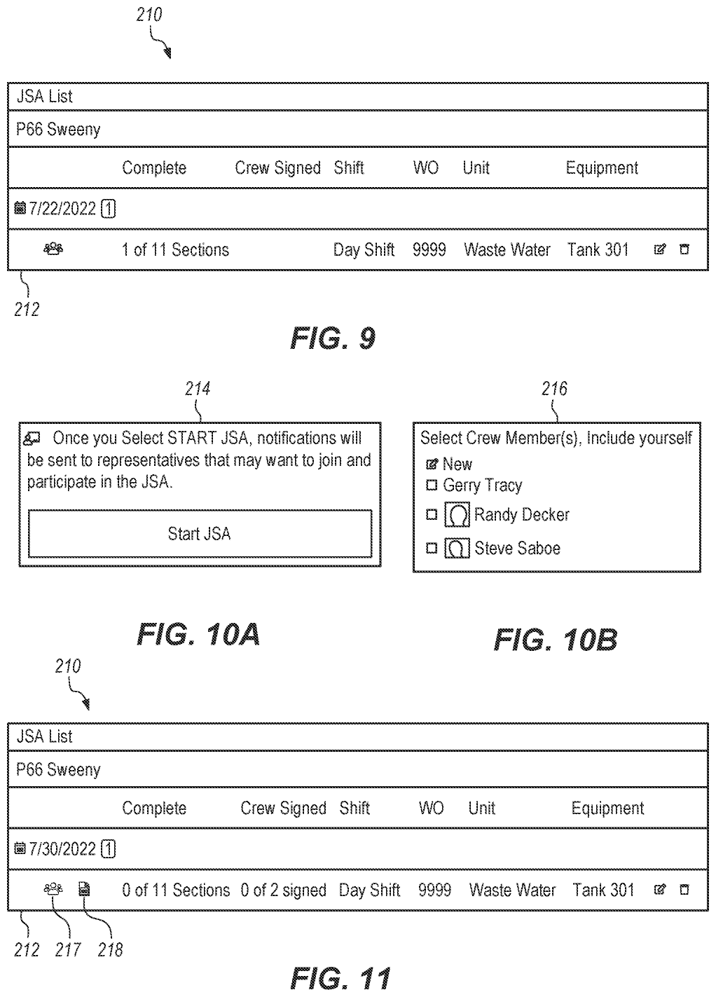

FIG. 9 is a diagram of a JSA list 210 showing a newly initiated or created JSA record 212 (dated Jul. 20, 2022) ready to receive user input. The JSA record 212 includes (or will include) both the information entered to create the JSA record as well as the entered personnel information and the hazard/mitigation entries.

FIG. 10A is a diagram of a “start JSA” popup 214 that may occur upon selection of the JSA record, such as JSA record 212, from the JSA list 210. FIG. 10B is a diagram of a “select crew member” popup or screen 216 that may occur after starting the selected JSA. The user may then select one or more crew members that will participate in the work associated with the JSA record 212. Optionally, the system may record the start time of the JSA record and the geolocation of the computing device where the JSA record is started.

FIG. 11 is a diagram of the JSA list 210 of FIG. 9, but with the people icon 217 in a green color (color not shown) to indicate completion of personnel entry and with the addition of a document icon 218 representing that the main JSA section of the JSA record 212 is now enabled for user input. The job leader can now use the document icon 218 to open the JSA card view.

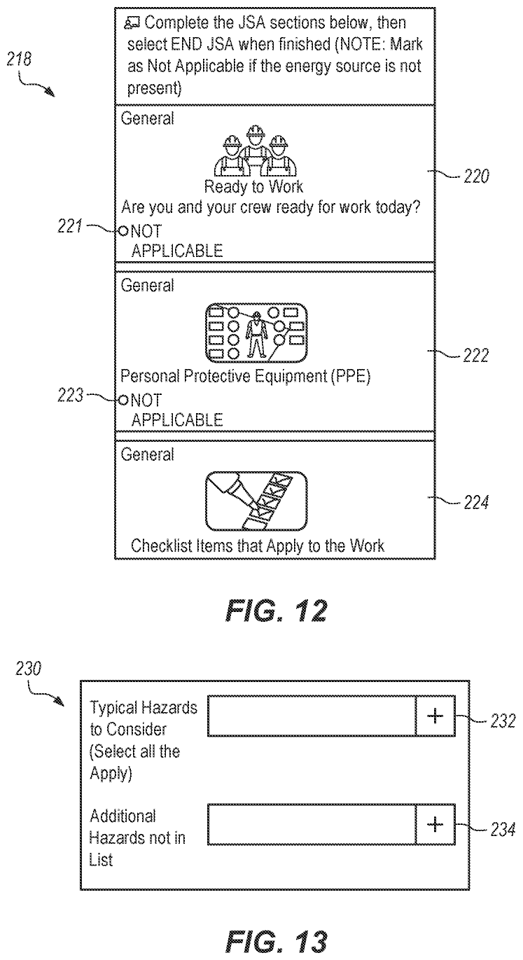

FIG. 12 is a diagram of a JSA document 218 (portion of the JSA record 212), including JSA modules or sections displayed as cards 220, 222, 224 that may be selected through user input. The user can provide user input, such as with buttons 221, 223, identifying whether each card is applicable or not. The card will collapse if the user marks the card as being “Not Applicable.” All actions are preferably reversable, so that if the card is initially marked “Not Applicable”, the system will display a new action that allows the job leader to move the card back to “Applicable.” Selecting (i.e., clicking) a card will open the card and allow the job leader to identify and mitigate the associated hazards:

FIG. 13 is a diagram of a hazard entry/selection screen or popup 230. The hazard entry/selection screen 230 may be displayed in response to selecting the “Ready to Work” card or module 220 in FIG. 12. A first “Typical Hazards to Consider” field 232 may be provided for a user to enter or select one or more hazards that are relevant to the job to be performed by the work crew. The hazard list may have been setup via button 162 of the setup menu 160 in FIG. 5. An “Additional Hazards” field 234 may also be provided for a user to enter a hazard that is not in the list of typical hazards to consider.

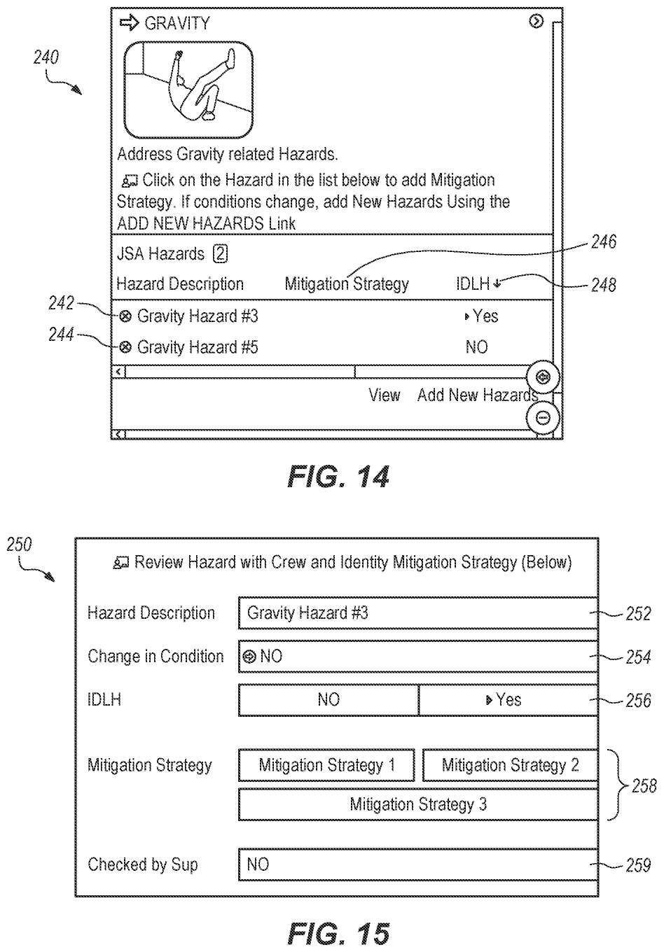

FIG. 14 is a diagram of a gravity-related hazards screen 240 listing two gravity hazards, Gravity Hazard #3 at 242 and Gravity Hazard #5 at 244. Each of the hazards 242, 244 that have been selected may become children records or modules for the JSA record (see JSA record 212 in FIGS. 9 and 11. Note the “X” next to each of the hazard names, which indicates that the hazard has not yet been addressed or mitigated via entry of a mitigation strategy (see column 246). A second column 248 indicates whether or not either of the hazards 242, 244 are immediately dangerous to life and health (IDLH). By selecting one of the individual hazards, the job leader can review and mitigate the hazard(s) by entering a mitigation strategy and discussing the same with the work crew.

FIG. 15 is a diagram of a mitigation screen 250 for reviewing a specific gravity hazard, selecting one or more mitigation strategies, indicating whether there has been a change in conditions, indicating whether the hazard is immediately dangerous to life and health (IDLH), and whether the hazard has been checked by a supervisory. In a Hazard Description field 252, the job leader may modify the hazard description to reflect the hazard more closely for this particular job. In the “Change in Condition” field 254, the job leader may manually identify, or the system may automatically identify, whether there has been a change in a condition. The first time the job leader reviews the related job hazards, the Change in Condition indicator should be “No”. However, if the JSA is complete and later in the shift the JSA is reopened and a new hazarded is added, the hazard description is modified or another mitigation strategy is selected, then the indicator may be changed to “Yes”. If the hazard is immediately dangerous to life and health (IDLH), the IDLH field or button 256 may be selected to make this indication. The user may then select one or more of the mitigation strategies (i.e., Mitigation Strategy 1, Mitigation Strategy 2, and/or Mitigation Strategy 3) using buttons 258. Finally, a “Checked by Supervisor” field or indicator 259 to indicate whether the completed JSA has been reviewed and approved. This indicator will change to “Yes” when the supervisor review is completed. Preferably, field 259 can only be modified by the supervisor (i.e., user with supervisory credentials identified via the setup menu).

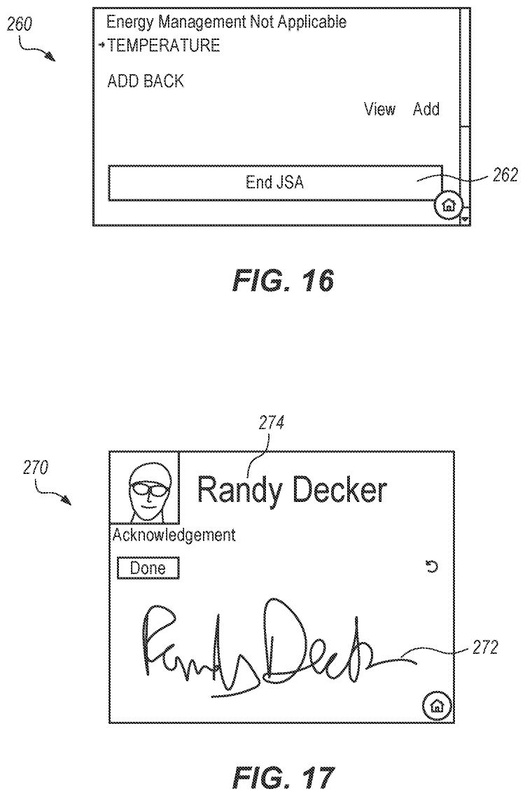

FIG. 16 is a diagram of a screen 260 for ending the JSA record after reviewing each of the hazards. When all the hazards are identified, reviewed and mitigated as determined by user input into the mitigation strategy field for each hazard), the “END JSA” button 262 will appear and/or be otherwise enabled. The Job leader may select (click) the button 262 to end the JSA. Subsequently, each job member or participant is required to sign the JSA record on the computing device.

FIG. 17 is a diagram of a screen 270 illustrating user input providing a signature 272 for an identified job member 274 to be associated with the JSA record. When all members of the job team have signed the JSA record, the supervisor may receive a notification and can view/approve the JSA record on their own computing device. Most preferably, the work should not begin until the supervisor has entered their approval, such as a “Yes” entry into field 259 of each hazard mitigation screen 250 of the JSA record. Optionally, a portable document format (PDF) document or a Microsoft Word document including all the identified hazards, mitigation strategies and crew member signatures may be automatically generated and attached to the JSA record.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-volatile computer readable medium and non-transitory program instructions embodied therein, the program instructions being configured to be executable by a processor to cause the processor to perform operations comprising:
providing a graphical user interface to a first computing device, wherein the graphical user interface is configured to accept user input into a job safety analysis record;
receiving user input into the graphical user interface, the user input identifying a plurality of hazards to be addressed by the job safety analysis record;
forming a module of the graphical user interface for each of the plurality of hazards, where each module identifies one of the hazards and displays an element for receiving user input identifying one or more mitigation strategies for the identified one of the hazards; and
preventing the job safety analysis record from being identified as completed until receiving user input identifying the one or more mitigation strategies for each of the plurality of hazards.

2. The computer program product of claim 1, wherein each module is arranged in a sequential order of modules, the operations further comprising:
enabling a current one of the modules to receive user input;
displaying the current module of the job safety analysis record;
receiving user input from the first computing device into the current module of the job safety analysis record; and
preventing a next one of the modules from being enabled to receive user input until receiving user input identifying the one or more mitigation strategies for the hazard identified in the current module.

3. The computer program product of claim 2, the operations further comprising:
collapsing one or more of the modules of the graphical user interface that are not presently enabled to receive user input; and
expanding the current module of the graphical user interface to display one or more element for receiving user input.

4. The computer program product of claim 3, wherein the one or more element for receiving user input is a text box, button and/or a menu of items.

5. The computer program product of claim 1, wherein each of the plurality of hazards are identified by receiving user input selecting from a predetermined menu of hazards, and wherein the one or more mitigation strategies for each identified hazard are identified by receive user input selecting from a predetermined menu of mitigation strategies for the identified hazard.

6. The computer program product of claim 5, the operations further comprising:
accessing a collection of safety incident records, wherein each of the safety incident records reference one of a plurality of past job safety analysis records;
identifying, for a subset of the job safety analysis records that each include an identified hazard, a safety effectiveness of one or more mitigation strategy identified in the job safety analysis record for mitigating the identified hazard, wherein the safety effectiveness is a measure of the relative number of safety incidents occurring while using the mitigation strategy during jobs that involved the identified hazard; and
highlighting, within the predetermined menu of mitigation strategies for the identified hazard, at least one of the one or more of the mitigation strategies that have the greatest safety effectiveness.

7. The computer program product of claim 1, the operations further comprising:
receiving an audio stream from a microphone that is connected to the first computing device during a duration the user input into the job safety analysis record;
performing voice analysis on the audio stream to determine a number of participants speaking in the audio stream; and
storing the determined number of participants in association with the job safety analysis record.

8. The computer program product of claim 1, the operations further comprising:
receiving an audio stream from a microphone that is connected to the first computing device;
performing voice recognition on the audio stream to determine an identity of one or more participants speaking in the audio stream; and
storing the determined identity of the one or more participants in association with the job safety analysis record.

9. The computer program product of claim 1, the operations further comprising:
forming a network connection with a second computing device, wherein the first computing device is located on a job site during the job safety analysis and the network connection with the second computing device is independent of a network connection with the first computing device;
receiving a first audio stream from a microphone that is connected to the first computing device during a duration of the user input into the job safety analysis record;
receiving a second audio stream from a microphone that is connected to the second computing device during the duration of the user input into the job safety analysis record;
determining, using the first audio stream, a first amount of speaking;
determining, using the second audio stream, a second amount of speaking; and
storing a value representing the second amount of speaking relative to the first amount of speaking.

10. The computer program product of claim 1, the operations further comprising:
receiving an audio stream from a microphone that is connected to the first computing device during a duration of the user input into the job safety analysis record;
forming a transcription of spoken words in the audio stream;
automatically determining a word count of the spoken words in the transcription; and
automatically sending a notification to a second computing device associated with a predetermined user in response to detecting that the word count is less than a predetermined number.

11. The computer program product of claim 1, the operations further comprising:
automatically sending a notification to a second computing device associated with a predetermined user in response to detecting that the first computing device has initiated a new job safety analysis record.

12. The computer program product of claim 11, wherein the first computing device is located on a job site during a duration of the user input into the job safety analysis record and the second computing device is not located on the job site during the duration of the user input into the job safety analysis record.

13. The computer program product of claim 12, wherein the second computing device is being operated by a company manager, a customer manager or a subject matter expert.

14. The computer program product of claim 11, wherein the notification includes a selectable link for the second computing device to form a network connection to receive a real-time feed of the user input to the job safety analysis record.

15. The computer program product of claim 14, wherein the real-time feed of the user input to the job safety analysis record includes an audio stream from a microphone that is connected to the first computing device.

16. The computer program product of claim 1, the operations further comprising:
automatically sending a notification to a second computing device associated with a predetermined user in response to detecting that the first computing device has modified a previously completed job safety analysis record.

17. The computer program product of claim 1, the operations further comprising:
receiving an image from a camera that is connected to the first computing device, wherein the image is a still image or a video;
performing image analysis on the image to determine a number of participants present during the user input into the job safety analysis record; and
storing the number of participants in association with the job safety analysis record.

18. The computer program product of claim 1, the operations further comprising:
receiving an image from a camera that is connected to the first computing device;
performing facial recognition on the image to determine an identity of one or more participants present during the user input into the job safety analysis record; and
storing the identity of the one or more participants in association with the job safety analysis record.

19. The computer program product of claim 1, the operations further comprising:
receiving a geolocation from a geolocation sensor on the first computing device during a duration of user input into the job safety analysis record; and
storing the geolocation of the first computing device in association with the job safety analysis record.

20. The computer program product of claim 1, the operations further comprising:
storing a first timestamp in response to initiation of user input into the job safety analysis record;
storing a second timestamp in response to completion of user input into the job safety analysis record; and
automatically sending a notification to a second computing device associated with a predetermined user in response to detecting that a duration of time between the first timestamp and the second timestamp is less than a predetermined amount of time.

21. The computer program product of claim 1, the operations further comprising:
forming a network connection with a second computing device authenticated with the administrative credentials; and
enabling the second computing device to form one or more template for a job safety analysis record directed to one or more jobs, crafts, and/or entities, wherein each template is formed with one or more fields that are pre-populated.

22. The computer program product of claim 1, the operations further comprising:
automatically searching historical safety incident records to identify one or more safety incident record having the same job, person or location as the job safety analysis record; and
displaying at least a portion of the one or more identified safety incident records on the graphical user interface for review during a duration of user input to the job safety analysis record.

23. The computer program product of claim 1, the operations further comprising:
receiving user input forming a list of participants present during the user input into the job safety analysis record; and
receiving and storing an electronic signature from each of the listed participants.

24. The computer program product of claim 1, the operations further comprising:
prompting each of a plurality of participants in the job safety analysis record to enter a signature prior to the completion of the job safety analysis record; and
preventing a status identifier for the job safety analysis record from indicating that the job safety analysis record has been completed without receiving a signature from each participant.

25. The computer program product of claim 24, the operations further comprising:
automatically sending a notification to a second computing device associated with a predetermined user in response the status identifier associated with the job safety analysis record indicating that the job safety analysis record has been completed;
receiving a reply from the second computing device indicating that the completed job safety analysis record has been reviewed by the predetermined user; and
storing a second status indicator indicating that the job safety analysis record has been reviewed by the predetermined user associated with the second computing device.

26. The computer program product of claim 1, the operations further comprising:
storing, for each of a plurality of job safety analysis records, the job safety analysis record in a database, wherein each job safety analysis record includes an identity of a job site and identifies whether the job safety analysis record has been completed;
receiving user input identifying a particular job site to be searched;
searching the database for job safety analysis records associated with the particular job site; and
displaying a map of the particular job site showing, for each job safety analysis record associated with the particular job site, an icon indicating the location within the particular job site where there is a job safety analysis in progress.

27. The computer program product of claim 26, wherein the icon forms a link to the job safety analysis record that is in progress at the location.

28. The computer program product of claim 1, the operations further comprising:
receiving biometric data from one or more health monitoring devices worn by a person during performance of a job that is the subject of the job safety analysis record, wherein the health monitoring device includes a heart rate sensor, body temperature sensor, electrocardiogram sensor, pedometer and/or posture sensor; and
analyzing, for each of the one or more health monitoring devices, the biometric data to identify a health alert for the person associated with the health monitoring device; and
automatically sending a notification to one or more computing devices indicating that the person wearing with the health monitoring device should use a mitigation strategy to address the health alert.

29. The computer program product of claim 28, wherein the health alert is selected from exhaustion, heat stress, influence of medication or other substance, physical impairment and/or mental impairment.

30. The computer program product of claim 1, the operations further comprising:
assigning a hazard score to each of the plurality of hazards in a predetermined menu of hazards;
calculating, for each of a plurality of job safety analysis records that have not been completed, a total hazard score as the sum of the hazard scores for each of the hazards identified in the job safety analysis record;
ranking the job safety analysis records that are not completed in order of the total hazard score; and
providing the ranking to a second computing device.

31. The computer program product of claim 1, the operations further comprising:
receiving an audio stream from a microphone that is connected to the first computing device;
performing speech analysis on the audio stream to determine whether any one or more of the participants in the job safety analysis are exhibiting an unsafe condition selected from mental state, behavior, medical condition, intoxication and/or a lack of knowledge about the job; and
automatically sending a notification to a second computing device identifying a determined unsafe condition.

32. The computer program product of claim 1, the operations further comprising:
establishing, for each of a plurality of participants in the job safety analysis record, communication with a smart device that is associated with the participant;
monitoring for input from the smart device associated with each participant;
receiving a user input from the smart device of one or more participant indicating that a potentially unsafe condition exists; and
automatically sending a notification to the first computing device indicating that user input was received indicating that the potentially unsafe condition exists.

33. The computer program product of claim 1, the operations further comprising:
identifying a location of a hazard within a job site associated with the job safety analysis record;
establishing, for each of a plurality of participants in the job safety analysis record, communication with a smart device that is associated with the participant;
determining that one of the participants is near the identified location of the hazard; and
automatically sending an alert to the smart device to notify the participant that they are near the hazard.

34. The computer program product of claim 33, wherein the location of the hazard is identified by a Bluetooth beacon and/or geotag, and wherein the alert is selected from a text message, audible alert, and/or vibration or other haptic.
